(19) United States
(12) Patent Application Publication
(10) Pub. No.: US 2007/0034562 A1
(43) Pub. Date: Feb. 15, 2007

(54) Washing device for pleated cartridges and filter comprising said device

(76) Inventors: Valerio Vernocchi, Cesena (IT); Alessandro Bassoli, Albareto (IT); Giovanna Delsante, Busnago (IT)

Correspondence Address: ARENT FOX PLLC, 1050 CONNECTICUT AVENUE, N.W., SUITE 400, WASHINGTON, DC, 20036, US

(21) Appl. No.: 10/546,765

(22) PCT Filed: Feb. 24, 2004
(86) PCT No.: PCT/IT04/00085

§ 371 Date: Oct. 12, 2006

(30) Foreign Application Priority Data
Feb. 25, 2003 (IT) MI2003 A 000335

(51) Int. Cl. B01D 63/00

(52) U.S. Cl. 210/321.69; 210/321.86; 210/413

(57) ABSTRACT

Washing device for one or more pleated cartridges (3) comprising a pleated filtering membrane (4) arranged around a perforated tube (5). Said washing device comprises a casing (1) which is provided with at least one discharge opening (9) and is suitable for containing said cartridges (3), as well as at least one motor (11) provided with a transmission member (13) suitable for being coupled in a removable manner with said cartridges (3) so as to rotate them around their longitudinal axis, wherein said casing (1) includes one or more nozzles (7) which are suitable for being supplied with washing liquid by at least one supply duct (8) and are turned towards the cartridges (3) for spraying the washing liquid toward the eternal surface of their pleated membrane (4) during the rotation imparted by said motor (11). The present invention also relates to a filter comprising said device.

### CROSS-REFERENCE TO RELATED APPLICATION

This application is a National Stage entry of International Application No. PCT/IT2004/000085, filed Feb. 24, 2004, the entire specification claims and drawings of which are incorporated herewith by reference.

The invention relates to a washing device for one or more pleated cartridges used for filtering liquids. The present invention also relates to a filter comprising said device.

The pleated cartridges for filters have a substantially cylindrical shape and comprise a pleated filtering membrane arranged around a tube in a plastic material provided with a plurality of holes on its lateral surface. The pleating lines of the membrane are parallel to the longitudinal axis of the tube, so that the pleats give a wide filtering surface to the liquids passing through them.

Filters using said pleated cartridges are known and commonly used. U.S. Pat. No. 4,561,979 discloses a liquid filtering device with a single pleated cartridge, formed of a tank divided into two portions. U.S. Pat. No. 5,174,896 mentions the problem that in a device as disclosed in U.S. Pat. No. 4,561,979 the efficiency of the pleated cartridge may be highly reduced by an excessive pressure of the liquid to be filtered that squashes the pleats, thereby reducing the usable filtering surface of the cartridge. For resolving this problem, U.S. Pat. No. 5,174,896 proposes a filtering system with a tangential inlet of the liquid to be filtered, so as to impart to the liquid a rotary motion which reduces the probability of squashing the pleats of the cartridge. Furthermore, the same patent specifies that the cartridge is preferably manufactured with pleats oriented so that the circulation of the liquid to be filtered tends to open the pleats, instead of closing them. U.S. Pat. No. 5,316,677 further discloses the embodiment of the cartridge with oriented pleats.

The efficiency of the pleated cartridge is reduced by the dirt gathering during the normal working on the outer surface of the filtering membrane, so that at regular time intervals a manual washing operation of the filter must be performed. This operation comprises the extraction of the cartridge from the filter, its washing with a jet of washing liquid, as well as the reintroduction of the cartridge in the filter.

It is an object of the present invention to provide a device which allows to automatically wash one or more pleated cartridges. Said object is achieved by means of a washing device and a filter, the main features of which are disclosed in claims 1 and 11, respectively, while other features are disclosed in the remaining claims.

In its simplest embodiment, for washing a single cartridge, the device according to the present invention comprises a casing with a discharge opening for discharging outside the washing liquid and the dirt, one or more washing nozzles oriented so that the jets produced by them insinuate themselves between the pleats of the cartridge, and a motor that during the washing rotates the cartridge to be washed, suitably arranged in the device for cleaning the whole pleated surface of the filtering membrane.

The liquid for washing the cartridge reaches the washing nozzles, which preferably produce a substantially blade-shaped jet oriented in a parallel manner with respect to the pleating lines of the filtering membrane, so as to insinuate itself between the pleats and tangentially hit their surface so as to obtain a dirt removal also with a mechanical action. Once removed, the dirt falls down together with the washing liquid and flows outwards through the discharge opening.

The filter comprising said washing device works with the same cartridges and alternates the washing steps with the filtering steps, so as to avoid the cartridge extraction. During the working as a filter, the discharge duct is closed by a valve, while the delivery duct delivers the liquid to be filtered inside the casing, thereby filling it. The liquid to be filtered passes through the pleated filtering membrane of the cartridge, thereby depositing the impurities thereon, passes through the holes of the perforated tube, goes up in the interspace between the perforated tube and a recovery tube and finally flows out of the casing.

When the filtering cartridge is too dirty, the valve on the delivery duct is closed and the valve on the discharge duct is opened. The casing is emptied from the liquid to be filtered and the nozzles are put in action for performing a washing operation of the cartridge as described above. When the washing operation is ended, the valve on the discharge duct is closed and the valve on the delivery duct of the liquid to be filtered is opened, so that the liquid to be filtered fills again the casing and the device starts to work again as a filter.

According to a particular aspect of the invention, the washing device and the filter comprise one or more nozzles oriented so that their jets hit in a substantially tangential manner the pleated surface of the filtering membrane, so that the dirt can be removed also by a mechanical action, without adding detergents or solvents.

According to another particular aspect of the invention, the washing device and the filter comprise one or more nozzles which produce a substantially blade-shaped jet, so that it can deeply penetrate between the pleats of the membrane, being oriented parallel to them.

According to a further particular aspect of the invention, the washing device and the filter comprise more nozzles arranged at different heights and in an offset manner, so that at the same time each jet washes different pleats of the cartridge or different sides of the same pleat with respect to the other jets. Furthermore, the cartridge can be rotated in such a direction that the pleats are washed at the top and then progressively downwards, so that the dirt removed by the first jet and that slides downwards along the surface of a pleat of the filtering membrane does not disturb the washing action of the second jet produced by the nozzle washing the same pleat immediately after.

Said nozzles are preferably arranged along one or more columns, so as to be precisely oriented for directing their jet in a tangential manner onto the pleated surface of the filtering membrane. The washing device and the filter can comprise more cartridges which can be simultaneously washed by one or more columns of nozzles and can be rotated by a single motor through a transmission system. The cartridges can also be arranged one on the other for reducing the horizontal size.

Unlike the known filters, the filter according to the present invention is modified for comprising the washing device of the cartridges, so that it is possible to wash them without extracting them from the casing of the same filter, with a consequent saving of maintenance time and costs.

In the filter, the cartridge can also be rotated during the filtering, so as to favor the entry of the liquid to be filtered between the pleats and to avoid their squashing.

The filter can also comprise a flow limiter for preventing the flow of the liquid to be filtered from becoming such as to squash the cartridge pleats or to cause the dirt to penetrate into the pores of the pleated filtering membrane, so that the cartridge cannot be washed anymore, but must be substituted. Said flow limiter can consist of one or more suitably calibrated holes, in particular arranged at the top of the recovery tube, so as to reduce the manufacturing costs.

The filter can further comprise reflux means arranged on the recovery duct which help the liquid filtered during the washing step to flow in the opposite direction, so that the dirt deposited on the filtered membrane of the cartridge, especially on its lower portion, can be removed more efficaciously from the inside.

Further advantages and features of the washing device and the filter according to the present invention will become clear to those skilled in the art from the following detailed and non-limiting description of some embodiment thereof, with reference to the attached drawings, wherein:

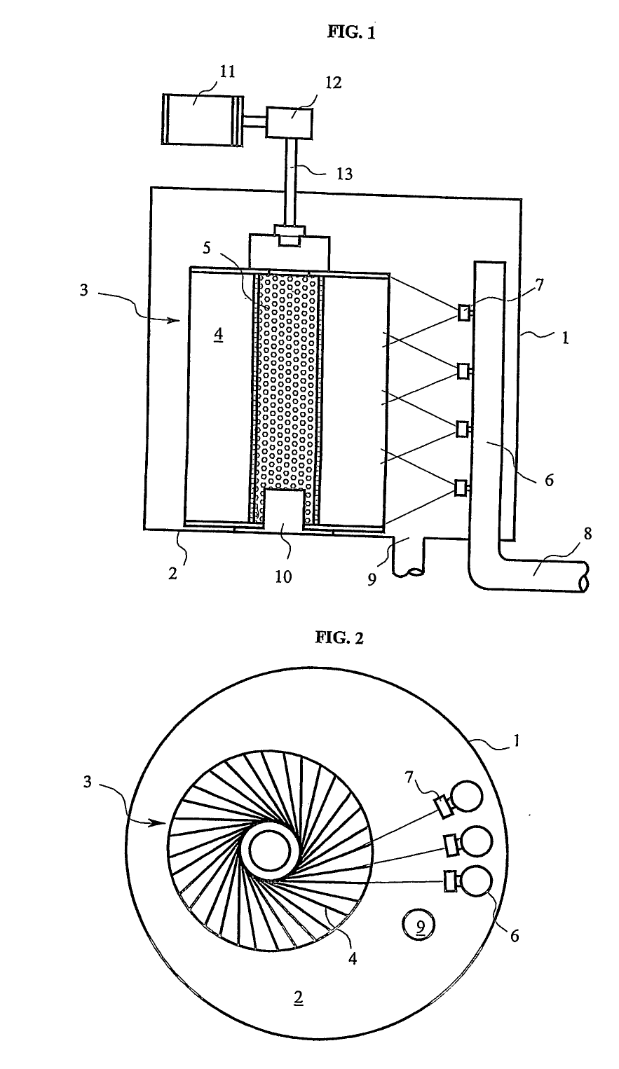

FIG. 1 shows a schematic view in a longitudinal section of a first embodiment of the washing device according to the present invention;

FIG. 2 shows a cross-sectioned view of a second embodiment of the washing device according to the present invention;

FIG. 3 shows a view in a longitudinal section of a first embodiment of the filter according to the present invention; and

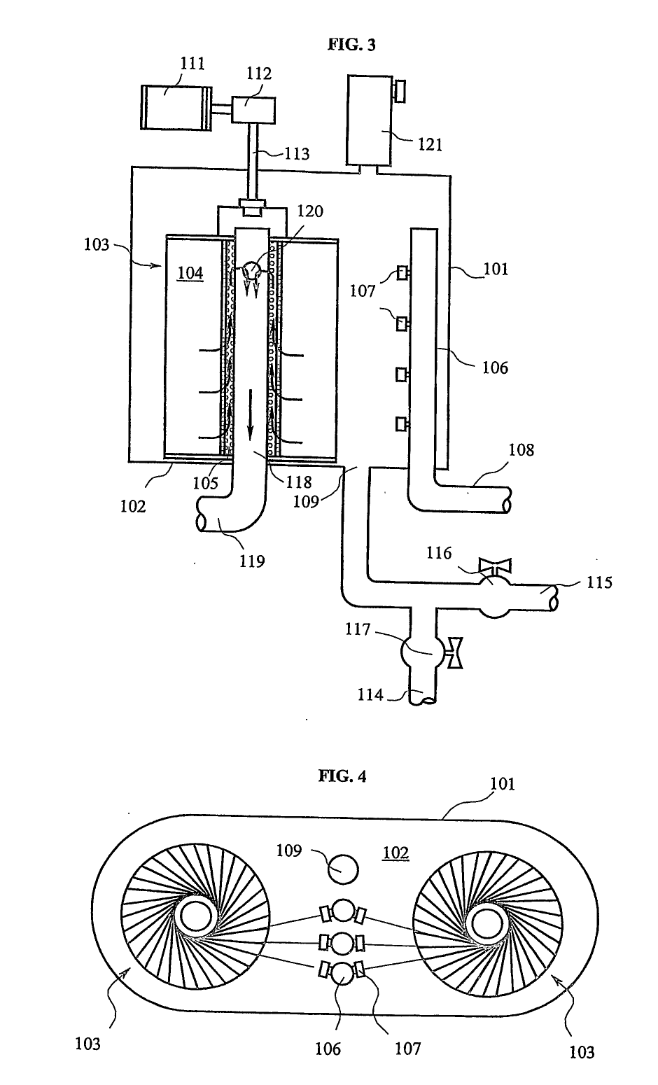

FIG. 4 shows a cross-sectioned view of a second embodiment of the filter according to the present invention.

Referring to FIG. 1, it is seen that the washing device according to the first embodiment of the invention comprises a casing 1 with a base 2, which can be opened and closed again, for example by means of an upper cover, for inserting a filtering cartridge 3 to be washed therein. This cartridge has a substantially cylindrical shape and comprises a pleated filtering membrane 4 arranged around a tube 5 made of a plastic material provided with a plurality of holes on its lateral surface. A column 6 protruding into casing 1 and comprising a plurality of nozzles 7 suitable for spraying a washing liquid, for example pure water or water with detergent, coming from at least one supply duct 8, is arranged on base 2. Nozzles 7 can be also directly fixed to the inner walls of casing 1, but since their orientation with respect to cartridge 3 is important for obtaining a good washing of the same, they are preferably arranged along one or more columns 6 which can be rotated around their longitudinal axis. An opening 9 for discharging the washing liquid and the dirt is also present on base 2. Cartridge 3 is placed in a rotating manner on a support 10 arranged on base 2, so that it can be arranged more precisely in casing 1 with respect to nozzles 7. The washing device according to the present invention further comprises a motor 11 which is provided with a reducer 12 and is mechanically connected to cartridge 3 by means of a transmission member, for example a shaft 13, suitable for being coupled in a removable manner with the same cartridge. Motor 11 and reducer 12 transmit a slow rotation to cartridge 3, for example 1 revolution per 4 minutes, so that the jets of washing liquid sprayed by nozzles 7 hit the pleated surface of the filtering membrane 4 in a substantially tangential manner and wash it in a uniform manner along the whole surface. For this purpose, the jets of washing liquid sprayed by nozzles 7 are preferably blade-shaped and parallel to the pleating lines of membrane 4. Reducer 12 allows to use also an asynchronous electric motor, which otherwise would have a too fast rotation speed. Anyway, motor 11 is preferably a continuous current motor, so as to easily varying its speed and adapt it to the kind of cartridge 3 and the kind of dirt to be eliminated. A motor for each cartridge or a transmission system which allows to move all the cartridges with a single motor can be provided in case of embodiments of washing devices suitable for washing more cartridges arranged on a same base.

Referring now to FIG. 2, it is seen that nozzles 7 are oriented so that the blade-shaped jet produced by them insinuates itself between the pleats of the filtering membrane 4 and tangentially hits their surfaces, thereby removing the dirt with an action also mechanical. The rotation speed of cartridge 3, if fast, could modify the angle with which the jet of nozzles 7 hits against the pleated surface of membrane 4, due to the composition of the two speeds. Also for this reason the rotation speed of cartridge 3 is preferably low. For a better working, the invention provides that nozzles 7 are arranged in an offset manner and at different heights, so that the dirt and the washing liquid sprayed by a nozzle 7 which slide downwards along the outer surface of the filtering membrane 4 do not disturb the washing action of the subsequent nozzle 7. For this purpose, cartridge 3 is rotated so that the jets coming from nozzles 7 wash membrane 4 by starting from the top and then by proceeding toward the lower portions.

In order to arrange nozzles 7 in an offset manner, the washing device according to the second embodiment of the invention comprises a series of more columns 6, for example three columns, each with at least one nozzle 7 arranged at a different height with respect to nozzles 7 of the other columns 6 and each oriented with a different angle, so as to direct the jet of nozzles 7 toward different pleats or to different sides of the same pleat, but at the same time so that each jet tangentially hits the surface of the pleat. The position of each column 6 therefore determines also the orientation of its nozzles 7. In the simplest case each column 6 has only one nozzle 7 arranged at different heights, so that all the nozzles wash cartridge 3 along its whole height. Furthermore, the discharge opening 9 is preferably arranged in a space comprised between nozzles 7 and cartridge 3, so as to immediately eliminate the washing liquid and the dirt that settle under the cartridge.

Other embodiments of the washing device according to the present invention can allow the simultaneous washing of more cartridges 3 arranged on a single base 2. For this purpose, a plurality of columns 6 provided with nozzles 7 oriented toward each cartridge 3 is arranged on base 2. In further embodiments of the washing device according to the present invention two or more cartridges 3 can be arranged one above the other in a coaxial manner and washed simultaneously. For this purpose, obviously, columns 6 must have a sufficient height and must be provided with a sufficient number of nozzles 7. In these cases support 10 is sufficiently long so as to allow the arrangement of more cartridges 3 one on the other and has a diameter sufficient to confer stability to the same cartridges during their rotation and washing.

Referring to FIG. 3, it is seen that the filter according to the first embodiment of the present invention comprises in a known way a waterproof casing 101 with a base 102, on which a filtering cartridge 103 comprising a pleated filtering membrane 104 arranged around a perforated tube 105 is arranged.

According to the invention, at least one column 106 provided with a plurality of nozzles 107 which are supplied with a washing liquid coming from a supply duct 108 is arranged on base 102. Also in this case nozzles 107 could be directly fixed to casing 101, but for the above mentioned reasons they are preferably arranged along one or more columns 106. An opening 109 made in base 102 allows the discharge of the dirt and the washing liquid through a discharge duct 114 as well as the delivery of the liquid to be filtered through a delivery duct 115. It is obvious that in other embodiments of the invention base 102 may also have two distinct openings, one for discharging the dirt during the washing and one for delivering the liquid to be filtered during the filtering. During the filtering step an inlet valve 116 arranged along the delivery duct 115 is open, while a discharge valve 117 arranged along the discharge duct 114 is closed. During the washing step, valve 116 is closed, while valve 117 is open. A recovery tube 118 connected to a recovery duct 119 is also present on base 102. Cartridge 103 is arranged on the recovery tube 118, so that an interspace in which the liquid filtered by membrane 104 flows is formed between the perforated tube 105 and the recovery tube 118. The recovery tube 118 can be provided with an opening near to its top and be slightly shorter than the perforated tube 105, or it can be closed at its top and be provided with one or more lateral openings arranged in proximity of its top. FIG. 3 shows the case in which the opening on the recovery tube 118 consists of a lateral hole 120. Finally, a vent 121 is arranged on the upper cover of casing 101.

A motor 111 is mechanically connected to cartridge 103 by means of a transmission member, for example a shaft 113, suitable for being coupled in a removable manner with the same cartridge, so as to rotate it slowly, for example at 1 revolution per 4 minutes. This rotation can be useful also during the filtering step so that the liquid to be filtered better insinuates itself between the pleats of the cartridge and does not squash them. In the known filters this arrangement is obtained by imparting a rotary motion to the liquid by means of a tangential inflow. The rotation of cartridge 103 occurs in a direction opposite to the orientation of the pleats of membrane 104, so as to favor the flow of the liquid to be filtered between the pleats, and is such as to not damage or completely open the same membrane. During the washing step, instead, the slow rotation of cartridge 103 is necessary so that the jets coming from nozzles 107 can wash the whole filtering surface of membrane 104. Motor 111 is provided with a reducer 112 for using also an asynchronous electric motor. As explained above, it is however preferable the use of a continuous current electric motor, the rotation speed of which is easily adjustable.

During the normal working of the filter according to the present invention, the liquid coming from the delivery duct 115 enters through opening 109 inside casing 101, thereby filling it completely thanks to vent 121. As indicated by the arrows, the liquid is urged through membrane 104 of cartridge 103, thereby leaving the impurities outside it, and, after passing through the holes of the perforated tube 105, enters into the interspace between this tube and the recovery tube 118. Then, the filtered liquid goes up in this interspace and after passes through opening 120, which also act as a flow limiter. Finally, the filtered liquid goes down into the recovery tube 118 and goes out from the device through the recovery duct 119.

The flow of the liquid to be filtered must not be bigger than a definite value per surface unit of the filtering membrane 104, in order to prevent a too big flow of liquid to be filtered from squashing the pleats of the membrane, thereby compromising its efficiency, or to prevent the impurities from penetrating into the pores of the membrane 104, thereby making its washing impossible. For this purpose, opening 120 is preferably calibrated and it is therefore suitable that the recovery tube 118 is closed at its top. Alternatively, a flow limiter can be arranged along the recovery tube 118, the recovery duct 119 or the delivery duct 115. Both the rotation of cartridge 103 by means of motor 111 and the presence of the calibrated hole 120 or of a flow limiter allow to avoid the squashing of membrane 104 in a simpler manner than in the known filters, in which a tangential inflow of the liquid is present for setting it in a rotating motion in a direction opposite to the orientation of the pleats. The recovery tube 118 suitably has a calibrated opening or one or more calibrated holes 115 at its top, so that the filter fills us completely and cartridge 103 works along its whole height.

During the washing step of cartridge 103 the filter is completely emptied by opening the discharge valve 117, by closing the inlet valve 116 and by discharging the liquid through the discharge duct 114. Column 106 with nozzles 107 is fed through the supply duct 108. Nozzles 107 spray the washing liquid with jets which are preferably blade-shaped and parallel to the pleating lines of membrane 104, so as to insinuate themselves between the pleats and to remove the dirt settled on the outer surface of the same membrane. The removed dirt, together with the liquid used for the washing, settles down and flows outside through opening 109 and the discharge duct 114. When the washing is ended the inlet valve 116 is opened, the discharge valve 117 is closed and the filter can return to its normal working.

Referring to FIG. 4, it is seen that the filter with the integrated washing device can comprise all the technical versions of the above embodiments of the washing device. In particular, nozzles 107 can be arranged at different heights on two or more columns 106, which can wash different pleats or different sides of the same pleat, so that the dirt removed above does not disturb with its descent the washing of the lower portions of the cartridge. In a way similar as disclosed for the washing device, if the filter is made for the simultaneous use of more cartridges 103 arranged on base 102, each column 106 can also be provided with more nozzles 107 oriented toward different directions for washing different columns. If the filter employs more cartridges 103 arranged on base 102, a single motor 111 provided with a transmission system which simultaneously rotates all cartridges 103 can always be used.

In other embodiments of the filter according to the present invention, the recovery duct 119 can be provided with reflux means, for example a pump or holes made in a no-return valve generally arranged along this duct, which in the washing step circulate a minimum quantity of filtered liquid in the inverse direction, so as to remove from the inside the dirt accumulated on the outer surface of membrane 104, in particular on its lower portion.

1. Washing device for one or more pleated cartridges (3) of the type having a pleated filtering membrane (4) arranged around a perforated tube (5), the washing device comprising a casing (1) which is provided with at least one discharge opening (9) and is suitable for containing said cartridges (3), as well as at least one motor (11) provided with a transmission member (13) suitable for being coupled in a removable manner with said cartridges (3) so as to rotate them around their longitudinal axis, wherein said casing (1) including one or more nozzles (7) which are suitable for being supplied with washing liquid by at least one supply duct (8) and are turned towards the cartridges (3) for spraying the washing liquid toward the external surface of their pleated membrane (4) during the rotation imparted by said motor (11), wherein the nozzles are oriented so that the jets of washing liquid sprayed by them hit in a substantially tangential manner the surface of the pleats or folding planes of the membranes of the cartridges.

2. Washing device according to claim 1, characterized in that the nozzles (7) are arranged at different heights in the casing (1).

3. (canceled)

4. Washing device according to one claim 1, characterized in that the nozzles (7) spray a jet, which is substantially blade-shaped and substantially parallel to the pleating lines of the membranes (4) of the cartridges (3).

5. Washing device according to claim 1, characterized in that the nozzles (7) are arranged in an offset manner so as to wash at the same time different pleats or different sides of the same pleat of the membranes (4).

6. Washing device according to claim 1, characterized in that the cartridges (3) are rotated so that the pleats are washed by the nozzles (7) first at the top of the membranes (4) and then progressively downwards.

7. Washing device according to claim 6, characterized in that the nozzles (7) are arranged on one or more columns (6) protruding into the casing (1).

8. Washing device according to claim 7, characterized in that the columns (6) are provided with a plurality of nozzles (7) oriented toward different directions for washing more cartridges (3) simultaneously.

9. Washing device according to claim 1, characterized in that the casing (1) is provided with a base (2) on which a support (10) suitable for supporting in a rotating manner at least one cartridge (3) is arranged.

10. Washing device according to claim 1, characterized in that the motor (11) is connected to a transmission system suitable for rotating more cartridges (3) simultaneously.

11. Filter for liquids provided with a casing (101) suitable for containing one or more pleated cartridges (103) comprising a pleated filtering membrane (104) arranged around a perforated tube (105), said casing (101) being connected to at least one delivery duct (115) for the liquid to be filtered and at least one recovery duct (119) for the liquid filtered by the filtering membrane (104), characterized in that said cartridges (103) are suitable for being coupled with a transmission member (113) mechanically connected to at least one motor (111) for rotating the cartridges (103) around their longitudinal axis, wherein said casing (101) including one or more nozzles (107) which are suitable for being supplied with washing liquid by at least one supply duct (108) and are turned toward the cartridges (103) for spraying the washing liquid toward the outer surface of their pleated membrane (104) during the rotation imparted by said motor (111), said casing (101) being further provided with at least one discharge opening (109) for discharging the washing liquid and the dirt removed from the pleated membrane (104) of the cartridges (103) during their washing and wherein the nozzles (107) are oriented so that the jets produced by them hit in a substantially tangential manner the surface o the pleats or folding planes of the membranes (104) of the cartridges (103).

12. (canceled)

13. (canceled)

14. (canceled)

15. Filter according to claim 11, characterized in that the nozzles (107) spray the washing liquid with a jet, which is substantially blade-shaped and substantially parallel to the pleating lines of the membranes (104) of the cartridges (103).

16. Filter according to claim 11, characterized in that the nozzles (107) are arranged in an offset manner so as to simultaneously wash different pleats or different sides of the same pleat of the membranes (104) of the cartridges (103).

17. Filter according to claim 16, characterized in that during the washing the cartridges (103) are rotated by the motor (111) in such a direction that the membranes (104) are washed by the nozzles (107) first at the top and then progressively downwards.

18. Filter according to claim 11, characterized in that the nozzles (107) are arranged on one or more columns (106) protruding into the casing (101).

19. Filter according claim 18, characterized in that the columns (106) are provided with a plurality of nozzles (107) oriented toward different directions for washing more cartridges (103) simultaneously.

20. Filter according to claim 11, characterized in that during the washing the cartridges (103) are rotated by the motor (111) in such a direction that the intrusion of the liquid to be filtered between the pleats of the membranes (104) is favored.

21. Filter according to claim 11, characterized in that the motor (111) is connected to a transmission system suitable for rotating more cartridges (103) simultaneously.

22. Filter according to claim 11, characterized in that the recovery duct (119) is connected to a recovery tube (118) protruding into the casing (101) and is arranged in the perforated tube (105) of a cartridge (103), so that between the perforated tube (105) and the recovery tube (118) an interspace in which the liquid filtered by the membrane (104) of said cartridge (103) can flow is formed.

23. Filter according to claim 11, characterized in that the recovery tube (118), the recovery duct (119) or the delivery duct (115) are provided with a flow limiter.

24. Filter according to claim 23, characterized in that the recovery tube (118) is provided with at least one calibrated hole (120) acting as flow limiter.

25. Filter according to claim 11, characterized in that the recovery duct (119) is provided with reflux means suitable for flowing the filtered liquid in an inverse direction through the membrane (104) during the washing step.

26. Washing device according to claim 4, characterized in that the nozzles (7) are arranged in an offset manner so as to wash at the same time different pleats or different sides of the same pleat of the membranes (4).

27. Washing device according to claim 26, characterized in that the cartridges (3) are rotated so that the pleats are washed by the nozzles (7) first at the top of the membranes (4) and then progressively downwards.
